(19) United States
(12) Patent Application Publication
(10) Pub. No.: US 2012/0229268 A1
(43) Pub. Date: Sep. 13, 2012

(54) METHOD AND APPARATUS FOR VEHICULAR DIRECTION INDICATION

(75) Inventors: Albert H. Butlin, JR., Beverly Hills, MI (US); James I. Holcomb, JR., Shelby, MI (US); Ryan D. Funk, Warren, MI (US)

(73) Assignee: GM GLOBAL TECHNOLOGY OPERATIONS LLC, DETROIT, MI (US)

(21) Appl. No.: 13/045,651

(22) Filed: Mar. 11, 2011

(51) Int. Cl. B60Q 1/34

(52) U.S. Cl. 340/465

(57) ABSTRACT

Methods and systems are provided for a vehicle. The method comprises activating a direction indicator on a vehicle responsive to receiving a user activation input and determining when the vehicle has completed a direction changing maneuver (e.g., lane change or turn). Thereafter, the direction indicator is automatically deactivated responsive to determining that the maneuver has been completed. The system comprises a user activation device and a processor configured to activate one or more of a plurality of vehicular direction indicators responsive to a user activation signal. The processor is also coupled to a plurality of vehicle sensors providing movement data related to the vehicle to the processor. By processing the movement data, the processor automatically deactivates the vehicle direction indicators upon determination that the vehicle has completed a maneuver (e.g., lane change or turn).

### TECHNICAL FIELD

The inventive subject matter generally relates to vehicular direction indication and more particularly to an automated system and method for vehicular direction indication while determining when a vehicular maneuver has completed.

### BACKGROUND

Various electromechanical systems for controlling the operation of vehicle direction indicators (commonly referred to as turn signals) are known and widely used in the automotive and related vehicular industries. In conventional automotive vehicles, it is common to have a user (driver) manipulate a direction indication lever to activate one or more direction indicators to indicate an intended direction of the vehicle to those external to the vehicle. Typically, a user can move the direction indication lever into an unlatched or latched position depending upon the amount of movement of the lever. If unlatched, the direction indication lever returns to a neutral position upon release which deactivates the direction indicator(s). Conversely, if the direction indicator lever is latched, it returns to the neutral position after sufficient steering wheel rotation unlatches the lever via mechanical means or the user manually unlatches the lever.

Relying upon mechanical or manual direction indicator lever control is problematic as all too often a direction indicator remains activated when no direction change or vehicular maneuver is intended. This can be troublesome for other vehicle operators or pedestrians who must decide what action(s) they can or should take given the continuous activation of the direction indicator.

### BRIEF SUMMARY

In accordance with an exemplary embodiment, a method for indicating vehicular direction is provided. The method comprises activating a direction indicator on a vehicle responsive to receiving a user activation input and determining when the vehicle has completed a direction changing maneuver (e.g., lane change or turn). Thereafter, automatically deactivating the direction indicator responsive to determining that the maneuver has been completed.

In accordance with another exemplary embodiment, a system for indicating vehicular direction is provided. The system comprises a user activation device and a processor configured to activate one or more of a plurality of vehicular direction indicators responsive to a user activation signal. The processor is also coupled to a plurality of vehicle sensors providing movement data related to the vehicle to the processor. By processing the movement data, the processor automatically deactivates the vehicle direction indicators upon determination that the vehicle has completed a maneuver (e.g., lane change or turn).

### DESCRIPTION OF THE DRAWINGS

The subject matter will hereinafter be described in conjunction with the following drawing figures, wherein like numerals denote like elements, and wherein:

FIG. 1 is a block diagram of a vehicle according to an exemplary embodiment;

FIG. 2 is an illustration of user controls for the vehicle of FIG. 1 according to an exemplary embodiment;

FIG. 3 is a flow diagram of a method according to an exemplary embodiment;

FIG. 4 is an exemplary illustration of a vehicular maneuver;

FIG. 5 is another exemplary illustration of a vehicular maneuver; and

FIG. 6 is an illustration of user controls for the vehicle of FIG. 1 in accordance with another exemplary embodiment.

### DETAILED DESCRIPTION

The following detailed description is merely exemplary in nature and is not intended to limit the subject matter or the application and uses of the subject matter. Furthermore, there is no intention to be bound by any expressed or implied theory presented in the preceding technical field, background, brief summary or the following detailed description.

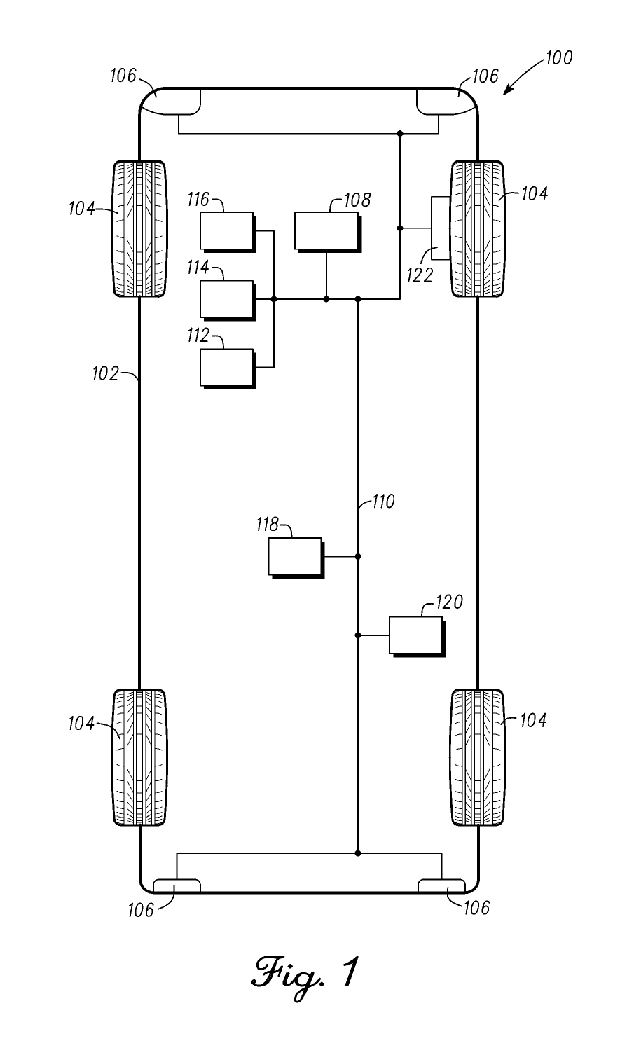

FIG. 1 is a block diagram of a vehicle 100, according to an exemplary embodiment. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD), or all-wheel drive (AWD). Generally, the vehicle 100 includes a chassis 102, wheels (or wheels and tires) 104 and direction indicators 106. Although illustrated as a four-wheeled vehicle, the vehicle 100 may be a two, three, four, or more wheeled vehicle. The vehicle 100 may also incorporate any one of, or combination of, a number of different types of engines (not shown), such as, for example, a gasoline or diesel fueled combustion engine, a flex fuel vehicle (FFV) engine (i.e., an engine that uses a mixture of gasoline and alcohol), a gaseous compound (e.g., hydrogen and/or natural gas) fueled engine, a combustion/electric motor hybrid engine (i.e., such as in a hybrid electric vehicle (HEV)), and an electric motor.

According to an embodiment, the vehicle 100 includes one or more processors 108 that communicate via a bus 110 to a plurality of controls and/or sensors. The bus 110 may be a serial or parallel bus of any type known in the art including, without limitation, USB, Firewire, a Controller Area Network (CAN—both single and dual wire systems), or a Local Interconnect Network (LIN).

The bus 110 communitively and operably couples the processor (or multiple processors) with a plurality of controls and sensors such as user controls (e.g., steering wheel and vehicle direction lever) 112, speed and acceleration (or de-acceleration) sensors 114, odometer 116, yaw sensor 118, global positioning system 120 and wheel (tire) rotation sensor 122. Although illustrated with one wheel rotation sensor 122, it will appreciated that each wheel 104 may have a rotation sensor, which may be incorporated into a traction control or anti-lock brake system of the vehicle 100. The bus 110 also couples the processor 108 with one or more vehicle direction indicators 106. In one embodiment, the processor can directly control each direction indicator by direct addressing, while in other embodiments, the processor 108 could communicate with a direction indication system (not shown) that in turn would manage activation and deactivation of the direction indicators 106 as controlled by the processor 108.

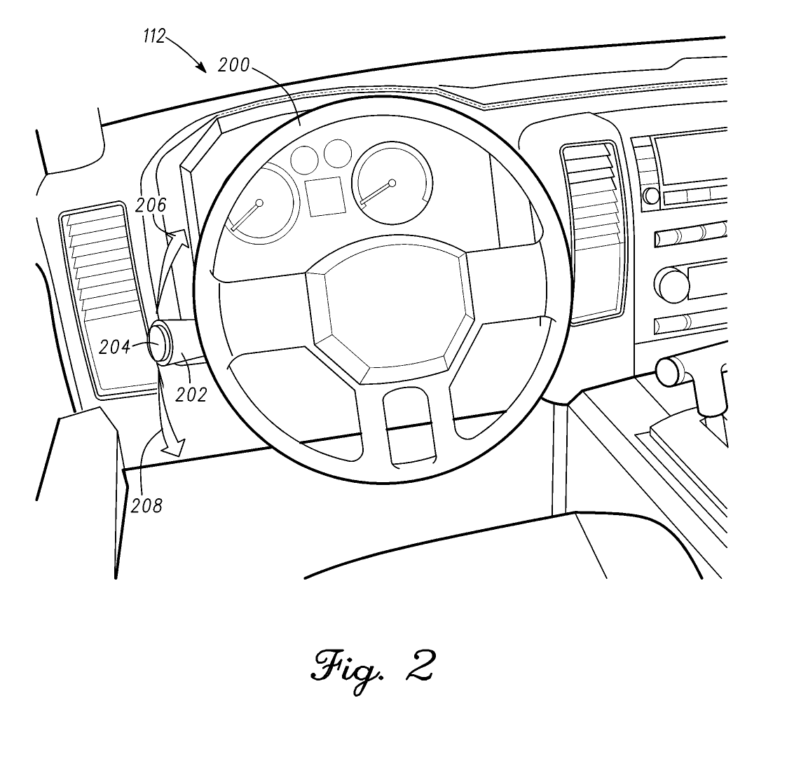

Referring now to FIG. 2, exemplary user controls 112 are illustrated and include a steering wheel 200 and a direction indication lever 202. Unlike conventional direction indication levers, embodiments of the present disclosure eliminates steering wheel based mechanical latching (and unlatching) mechanisms for the advantages afforded by an automated, processor controlled vehicle direction indication system.

According to the embodiments of the present disclosure, a vehicular change of direction or maneuver is indicated by a user simply moving the direction indication lever 202 in an upward direction 206 or a downward direction 208. Typically, movement in the upward direction 206 would indicate a user intention for the vehicle to move toward the right (from the viewpoint of the user), while movement in the downward direction 208 would indicate a user intention for the vehicle to move toward the left (e.g., a lane change to the left or a left-hand turn). In one embodiment, the direction indication lever 202 has no latching mechanism whatsoever, and returns to a neutral (centered) position upon release. Accordingly, the direction indication lever 202 includes a cancellation button 204, which causes the processor 108 to deactivate the direction indicators 106. In another embodiment, the direction indication lever 202 may have a latch that is automatically released by the processor upon determination that the vehicular direction change or maneuver has been completed. This later embodiment has the advantage of familiar operation (from the user's point of view) of the direction indication lever 202, although the direction indication system is functioning in an entirely different manner in accordance with the embodiments of the present disclosure.

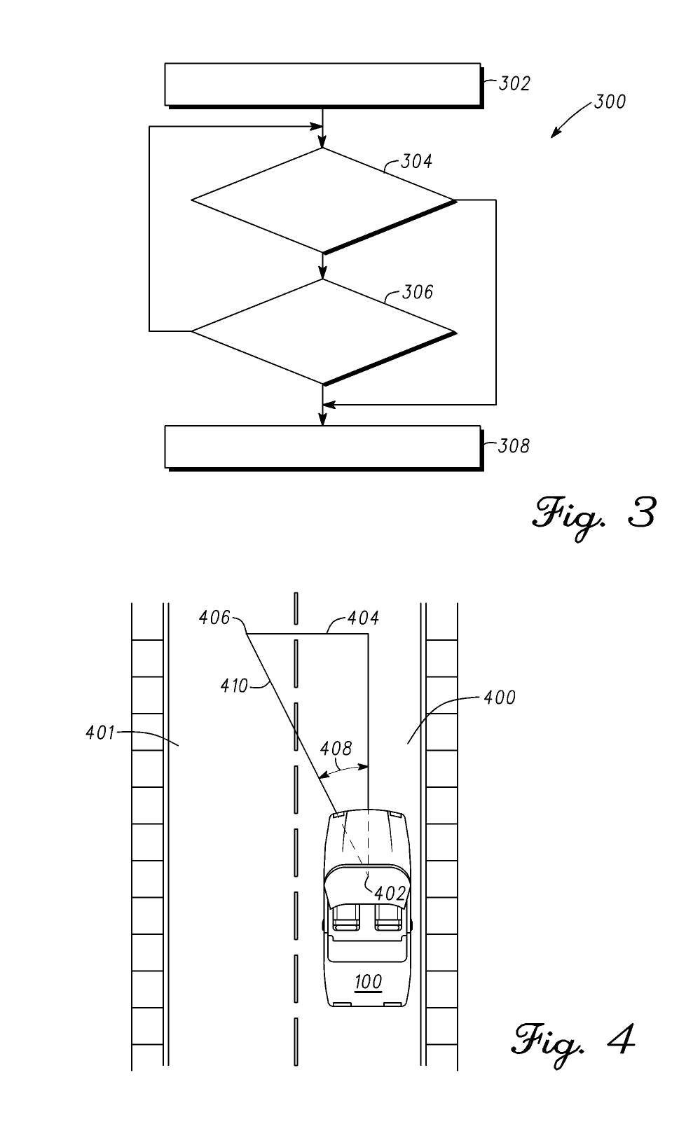

Referring now to FIG. 3, a flow diagram 300 illustrating exemplary methods of the present disclosure is shown. In step 302, a user activates the vehicular direction indication system by moving the direction indication lever (202 of FIG. 2). This provides an activation input (or signal) to the processor (108 of FIG. 1), which in turn activates one or more direction indicators (106 of FIG. 1). As is known, the direction indicators 106 periodically illuminate (or flash) when activated to indicate an intended direction change or maneuver of the vehicle. Next, decision 304 determines whether the user has sent a cancellation input (or signal) to the processor. If the determination of decision 304 is that the user has not cancelled the intended vehicular maneuver, decision 306 determines whether the vehicular maneuver has been completed. That is, according to the various embodiment of the present disclosure, the user simply needs to indicate the direction of an intended vehicular maneuver (be it a lane change or turn) and the processor (108 of FIG. 1) determines when the maneuver has been completed and then automatically cancels (or deactivates) the direction indicators (106 of FIG. 1) without further user input, including not relying upon steering wheel (200 of FIG. 2) rotation. If the determination of decision 306 is that the maneuver is not completed, the routine returns to decision 304 to determine if a user cancellation input (or signal) has been received. If however, the determination of decision 306 is that the maneuver has been completed, or upon determination in decision 304 that a user cancellation input has been received, the routine proceeds to step 308 where the vehicular direction indicators (106 of FIG. 1) are deactivated.

Returning to decision 306 of FIG. 3, the present disclosure contemplates a number of embodiments for determination when a vehicular maneuver (e.g., lane change or turn) has been completed. In one embodiment, the processor uses vehicle motion data provided by the global positioning system (GPS) (120 of FIG. 1) to determine when a vehicle has moved to a different lane or has made a turn. In another embodiment, the processor computationally determines when the vehicle has completed the maneuver, which can be done in a number of ways with vehicle motion data provided by various sensors such as those illustrate in FIG. 1. For example, the processor can determine the distance traveled by the vehicle from the point of receiving the user input (step 302 of FIG. 3) by checking the odometer data (from sensor 116 of FIG. 1), from the GPS (120 of FIG. 1) data, by calculating vehicle velocity (e.g., speed or speed and acceleration/de-acceleration from sensor 114 of FIG. 1) over a time interval measure from the point of receiving the user input (step 302 of FIG. 3) or by calculating wheel (tire) rotation data (from sensor 122 of FIG. 2) over a time interval measure from the point of receiving the user input. With distance information, the processor can determine vehicular maneuver progress by computing distance traveled with factors such as steering wheel angle or steering wheel angle rate of change (from user controls 112 of FIG. 1) or vehicle yaw or yaw rate of change (from sensor 118 of FIG. 2). In any of the foregoing embodiments, the processor (108 of FIG. 1) determines when the vehicular change of direction or maneuver has been completed and automatically deactivates the direction indicators (106 of FIG. 1).

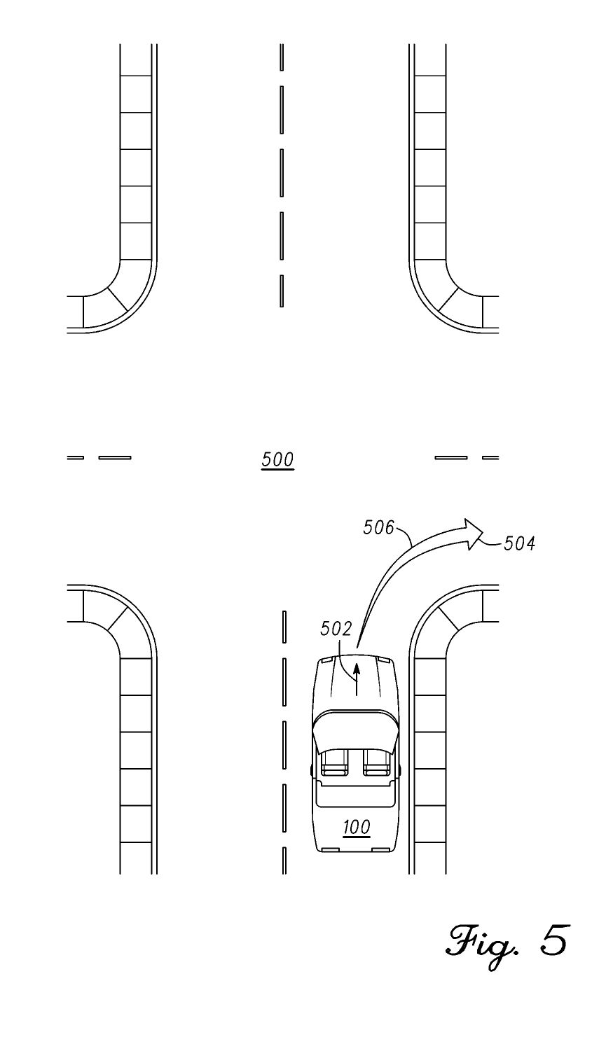

The multitude of embodiments contemplated by the present disclosure offer several advantages over conventional direction indication systems. Turning now to FIG. 4 and FIG. 5, exemplary vehicle maneuvers are illustrated for facilitating understanding some of these advantages. In FIG. 4, an exemplary lane change maneuver is illustrated. For this maneuver, the objective of the processor (108 in FIG. 1) is to determine when the vehicle has moved from driving lane 400 to driving lane 401. In one embodiment, the processor determines when a reference point (e.g., the center or center of gravity 402) of the vehicle 100 have moved to a position indicated as 406 in driving lane 401. The processor can make this determination by comparing GPS data for the reference point 402 to the destination point 406 as provided by the global positioning system (120 in FIG. 1). Alternately, the processor can compute when the reference point 402 of the vehicle has moved in the direction indicated by the user input (step 302 in FIG. 3) a distance indicated by 404, which would place the center of the vehicle at the center of the driving lane 401 at the point indicated at 406. Such a computation can be made by the processor using a number of sensors to determine with the vehicle has traveled a distance indicated by 410 and the vehicle angular direction (e.g., steering wheel position or yaw) indicated by 408.

One of the many advantages afforded by the present disclosure is the ability for the processor to dynamically select, change or adapt (weight) which sensor (or combination of sensors) the processor employs to evaluate vehicle motion data. For example, for dry road conditions (known for example by the windshield wipers being OFF), it may be advantageous to use odometer data to determine when the distance 410 has been traveled. However, in slippery road conditions (determined for example by data from the traction control system), it may be more accurate to determine when the distance 410 has been traveled by using wheel (tire) rotation data from wheel(s) known to have traction during the maneuver. Optionally, it may be advantageous for the processor to compute the distance 410 and vehicle angular direction 408 using multiple sets of motion data from different combination of sensors and weighing the motion data depending upon driving conditions.

Referring now to FIG. 5, another exemplary maneuver (a right-hand turn) is illustrated. In this maneuver, the objective of the processor (108 in FIG. 1) is to determine when the vehicle 100 has changed direction from that indicated at 502 to the direction indicated at 504 along a path indicated at 506. As discuss above, the present disclosure contemplates a number of factors that may be included in vehicle motion data evaluated by the processor to determine when the maneuver has been completed. For example, it may be advantageous to use GPS data (or the compass heading of GPS data) to quickly determine when a turn has been completed. However, in slippery road conditions, it may be advantageous for the processor to dynamically select for factoring into the maneuver determination the vehicle yaw rate (or yaw rate of change) in the event the vehicle loses fraction and spins during the turn maneuver.

Whether the many embodiments of the present disclosure are implemented with one fixed set of factors for the vehicle motion data or multiple factors dynamically varied and/or weighted according to driving conditions, the present disclosure offers both advantages and convenience to the user of the vehicle over the simple and dated mechanical direction indication system of the past.

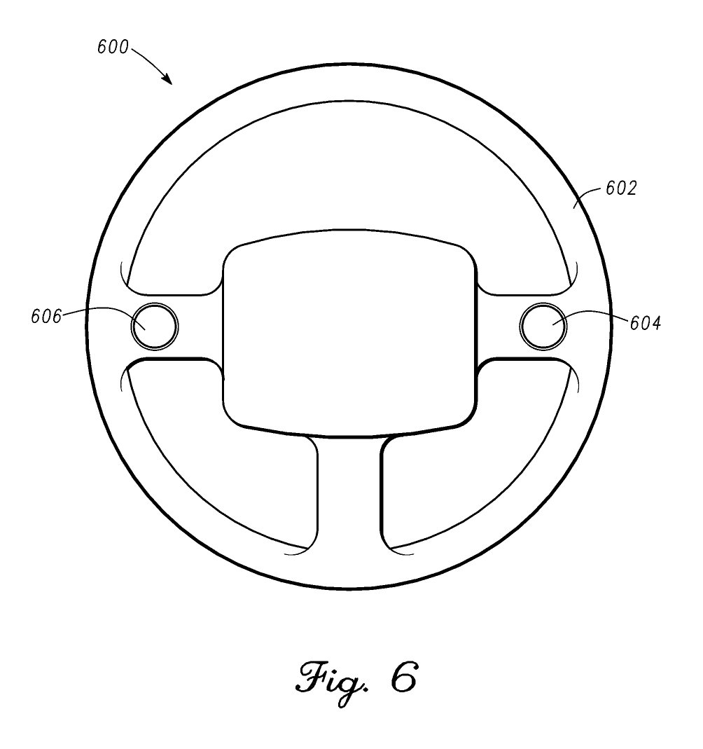

Referring now to FIG. 6, an alternative exemplary embodiment of a steering wheel/direction indicator arrangement 600 is illustrated. Since the vehicle direction indicator (202 in FIG. 2) no longer requires the mechanical latch and release mechanisms of conventional direction indication systems, a vehicle steering wheel 602 can have direction indicator controls incorporated therein. As can be seen, a right-direction maneuver can be indicated by the user activating the button 604, while a left-direction maneuver can be indicated by the user activating the button 606. This allows the user to remain in a driving position and not move a hand or change grip to be able to activate the direction indicator. While illustrated as a button, those skilled in the art will appreciate that the direction indicator controls 604 and 606 may be various switches, slides, optical sensors, heat sensors, touch sensors, etc. for the convenience of the user.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing the exemplary embodiment or exemplary embodiments. It should be understood that various changes can be made in the function and arrangement of elements without departing from the scope of the inventive subject matter as set forth in the appended claims and the legal equivalents thereof.

What is claimed is:

1. A method for indicating vehicular direction, comprising:
activating a direction indicator on a vehicle via a processor responsive to receiving a user activation input;
determining via the processor when the vehicle has completed a lane change maneuver; and
deactivating the direction indicator responsive to the processor determination that the lane change maneuver has completed.

2. The method of claim 1, which includes the step of deactivating the direction indicator responsive to the processor receiving a user deactivation input.

3. The method of claim 1, wherein the determining step further comprises determining when the lane change maneuver has completed by processing global positioning data related to the vehicle.

4. The method of claim 1, wherein the determining step further comprises the processor evaluating vehicle motion data comprising sensor information dynamically selected by the processor.

5. The method of claim 1, wherein the determining step further comprises determining when the lane change maneuver has completed by the processor determining a distance traveled by the vehicle together with one or more of the following group of vehicle factors: steering angle; steering angle rate of change; yaw or yaw rate of change.

6. The method of claim 5, wherein the step of determining the distance traveled by the vehicle further comprises the processor receiving odometer data of the vehicle.

7. The method of claim 5, wherein the step of determining the distance traveled by the vehicle further comprises the processor computing velocity data of the vehicle for a time interval after receiving the user activation input.

8. The method of claim 7, wherein the step of determining the distance traveled by the vehicle further comprises the processor computing velocity and acceleration data of the vehicle for the time interval after receiving the user activation input.

9. The method of claim 7, wherein the step of determining the distance traveled by the vehicle further comprises the processor computing velocity and de-acceleration data of the vehicle for the time interval after receiving the user activation input.

10. The method of claim 5, wherein the step of determining the distance traveled by the vehicle further comprises the processor computing tire rotation for a time interval after receiving the user activation input.

11. A method for indicating vehicular direction, comprising:
activating a direction indicator on a vehicle via a processor responsive to receiving a user activation input;
determining via the processor when the vehicle has completed a turn maneuver; and
deactivating the direction indicator responsive to the processor determination that the turn maneuver has completed.

12. The method of claim 11, which includes the step of deactivating the direction indicator responsive to the processor receiving a user deactivation input.

13. The method of claim 11, wherein the determining step further comprises determining when the turn maneuver has completed by processing global positioning data related to the vehicle.

14. The method of claim 11, wherein the determining step further comprises the processor evaluating vehicle motion data comprising sensor information dynamically selected by the processor.

15. The method of claim 11, wherein the determining step further comprises determining when the turn maneuver has completed by the processor determining a distance traveled by the vehicle together with one or more of the following group of vehicle factors: steering angle; steering angle rate of change; yaw or yaw rate of change.

16. The method of claim 15, wherein the step of determining the distance traveled by the vehicle further comprises the processor receiving odometer data of the vehicle.

17. The method of claim 15, wherein the step of determining the distance traveled by the vehicle further comprises the processor computing velocity data of the vehicle for a time interval after receiving the user activation input.

18. The method of claim 17, wherein the step of determining the distance traveled by the vehicle further comprises the processor computing velocity and acceleration data of the vehicle for the time interval after receiving the user activation input.

19. The method of claim 17, wherein the step of determining the distance traveled by the vehicle further comprises the processor computing velocity and de-acceleration data of the vehicle for the time interval after receiving the user activation input.

20. The method of claim 15, wherein the step of determining the distance traveled by the vehicle further comprises the processor computing tire rotation for a time interval after receiving the user activation input.

21. A system for indicating vehicular direction, comprising:
a user activation device;
a processor operably coupled to the user activation device for receiving a user activation input;
a plurality of vehicular direction indicators responsive to the processor to selectively illuminate to indicate vehicular direction; and
a plurality of vehicle sensors operably coupled to the processor for providing motion data related to the vehicle;
wherein, the processor activates at least some of the plurality of vehicle direction indicators responsive to the user activation input and deactivates the vehicle direction indicators when the processor determines from the motion data that the vehicle has completed a maneuver.

22. The system of claim 21, wherein the plurality of vehicular sensors comprise one or more of the following group of sensors: odometer, steering angle; steering angle rate of change; yaw; yaw rate of change; tire rotation or global positioning data.

23. The system of claim 21, wherein the maneuver comprises a lane change maneuver.

24. The system of claim 21, wherein the maneuver comprises a turn maneuver.

25. The system of claim 21, further comprising a user de-activation device.

26. The system of claim 21, wherein the motion data comprises information from a set of the plurality of sensors dynamically selected by the processor.
